(19) United States
(12) Patent Application Publication
(10) Pub. No.: US 2005/0115621 A1
(43) Pub. Date: Jun. 2, 2005

(54) Mobile dual containment highway tank

(76) Inventors: Maury G. Van Vliet, Spruce Grove (CA); Karl T. Heck, St. Albert (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 10/724,143

(22) Filed: Dec. 1, 2003

(51) Int. Cl. G05D 7/00

(52) U.S. Cl. 137/899

(57) ABSTRACT

A highway tank made of steel or aluminum for transporting fluids such as diesel and jet fuel to remote sites, and providing the necessary containment features to store the fluids at remote sites. The highway tank comprises an inner and an outer wall with a space providing at least 110% containment. The highway tank may also comprise fuel-forwarding equipment which can include a hose and hose reel, internal or external pump, a fuel meter, a generator and a fuel filter, as well as a drip tray. The highway tank may be top loaded, bottom loaded, or both. The highway tank includes overfill protection and spill control features. The highway tank may be divided into compartments.

### BACKGROUND OF THE INVENTION

Operators of machinery such as heavy equipment or helicopters on remote sites are required to have spill containment for their fuel storage system. This has been done by either transporting a dual containment tank, which must be transported empty, out to a site where it is filled by a highway tank, or by creating a berm around a highway tank and lining it with an impermeable liner. Both options present difficulties for temporary sites. While a dual containment tank does not require any on-site construction, it must be filled on site and emptied before being transported to the next site. Creating a berm takes time as well as expense, and poses more difficulties if it is done in cold weather, where the lining may freeze to the ground, making it difficult to remove.

### SUMMARY OF THE INVENTION

This invention provides a highway tank that can transport fuel to a site, as well as provide the necessary containment features to store the fuel on-site in the same, and a method of using the tank.

There is therefore provided, according to an aspect of the invention, a highway tank for onsite refueling without requiring separate provision of dual containment at the site. The highway tank is double walled and mobile. According to an aspect of the invention a tank, which may be substantially cylindrical is mounted horizontally on a chassis and supported by ground engaging wheels, with a fluid transfer system connected to the tank for filling and discharging the tank.

According to an aspect of the invention, the highway tank comprises fuel-forwarding equipment. The fuel-forwarding equipment may include a fuel filter, a generator, a hose, a hose reel, and a fuel pump. The fuel forwarding equipment may be located in a cabinet below the tank or in front of the tank. The generator may be located a safe distance from the fuel pump. There may be a sliptank to store fuel separate from the tank, to fuel the generator, for example.

According to an aspect of the invention, the tank is bottom loaded. The fluid transfer system for a bottom loaded tank may comprise a level sensor, a vent, and a bottom loading valve. The fluid transfer system may comprise a fuel filter, a generator, a hose, a hose reel, and a fuel pump. The valve system may comprise anti-siphon protection.

According to an aspect of the invention, the tank is top loaded using a top loading valve system. The top loading valve system may comprise overfill protection. According to a further aspect of the invention, the tank is divided into plural sections for separating fuel, each section having a valve system for loading and unloading the section. According to a further aspect of the invention, the tank comprises baffles on the interior of the tank.

According to an aspect of the invention, the highway tank comprises a drip tray. The drip tray may comprise the bottom of a cabinet under the tank, the bottom of the cabinet having a surrounding wall below the access to the cabinet and the bottom having a drain to remove any fluid.

Further aspects of the invention will be found in the claims and detailed description that follow.

### BRIEF DESCRIPTION OF THE DRAWINGS

There will now be given a description of a preferred embodiment of the invention, by way of illustration only and not with the intent of limiting the invention, where like reference characters denote like elements, and where:

FIG. 1 shows the highway tank with an enlarged view of the fuel forwarding equipment;

FIG. 2 shows an elevation view of the highway tank;

FIG. 3 shows a side view of the highway tank;

FIG. 4 shows an end view of the highway tank;

FIG. 5 shows a front view of the highway tank;

FIG. 6 shows a bottom loaded double-walled tank trailer;

FIG. 6a shows a top loaded double walled tank trailer; and

FIG. 7 shows the valve system with an auxiliary line.

### DETAILED DESCRIPTION OF PREFERRED EMBODIMENTS

The word comprising is used in this document in its inclusive sense and does not exclude other features being present. The indefinite article “a” before an element specifies at least one of the elements is present, but does not exclude others of the same element being present. Substantially cylindrical in relation to a tank means that in cross-section the tank walls have no sharp corners. All corners in the cross-section of the tank are rounded. Oval, oblate, elliptical, and circular tanks in cross-section are all substantially cylindrical.

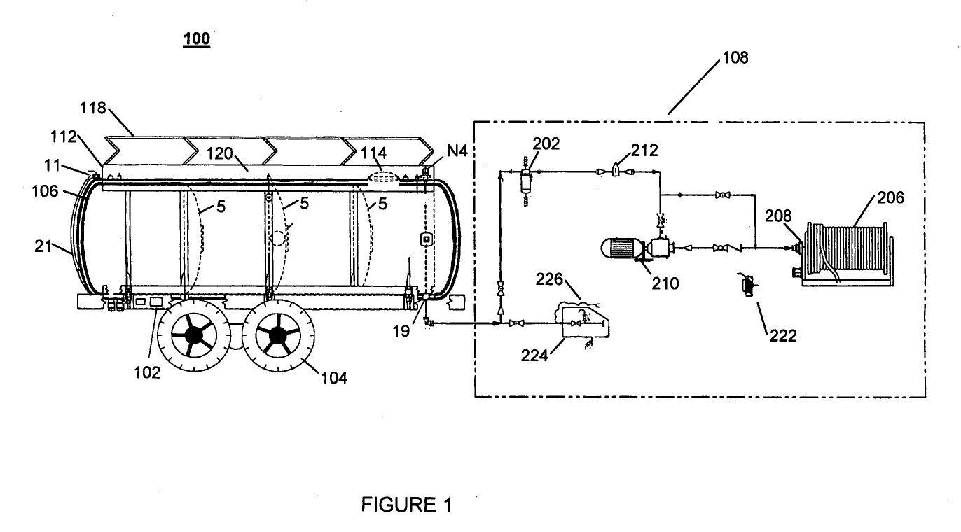

Referring now to FIG. 1, there is shown a double-walled mobile highway tank 100 for onsite refueling, the highway tank comprising a chassis 102, ground engaging wheels 104 supported by the chassis, and a tank 106 that is substantially cylindrical and double-walled. The tank is mounted on the chassis 102 in a horizontally disposed manner, and a fluid transfer system 108 is connected to the tank 106 for filling and discharging the tank 106. The tank may also have a rectangular shape. The tank may also be disposed to be removed from the wheels and transported by a helicopter.

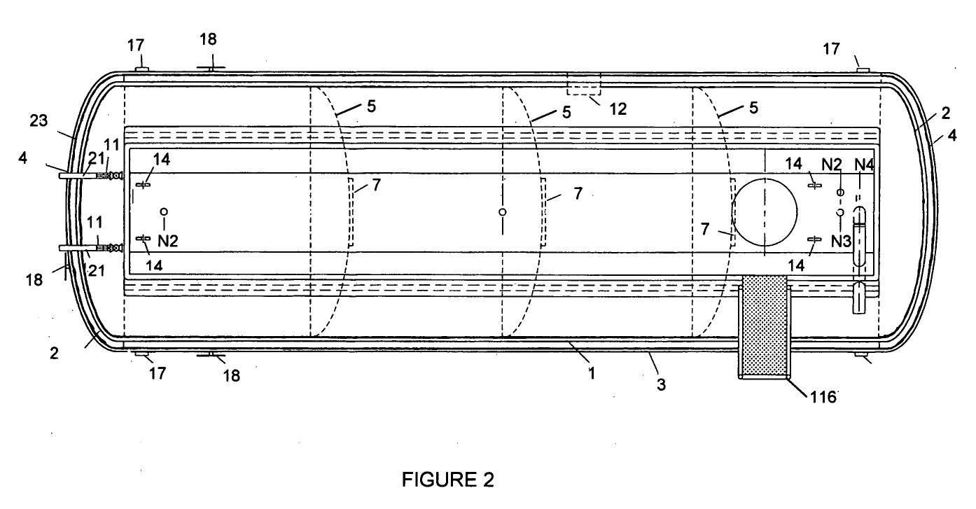

Referring to FIG. 2, there is shown a double walled tank 106 having an inner shell 1 and an outer shell 2 forming an airspace 110 between the inner and outer shells. The air space 110 need not be uniform around the inner shell 1. It is preferable that the tank 106 has at least 110% containment, and may be described as having integral secondary containment. The highway tank 100 is constructed to make the tank safe for transporting fluids such as fuel, according to standards Transport Canada 406 in Canada and/or Department of Transportation 406 in the United States. For example, the tank must be pressure sealed up to the rated pressure, with the necessary horizontal reinforcement; if the tank wall thickness is less than ⅜ inch, there would need to be baffles at 60 inch on center; and the valving satisfying the standard would also be included. The tank is also constructed to meet standards for storing fluids on site. The highway tank 100 may also include features such as a hood 112 to cover any piping, and repad 10 to stiffen the tank against torque. As well, a manhole 114 for internal examination of the tank 106 is provided, and a ladder 116 to the top 115 of the tank 106 and a collapsible handrail 118 along a walkway 120 on the top 115 of the tank 106 may be included. Other features such as a walkway drain 11 with a flexible drain hose 21, lifting lugs 14, lighting mounts 17, and a placard 18 indicating dangerous goods may also be included according to the use of the tank trailer. The tank 106 is also provided with a drain N6 for the airspace 110 to check for any leaks in the inner shell 1 and to drain any leaked fluid. There is also a drain N5 for the inner tank 1 to empty the tank 106 in the event that there is a leak to be repaired, to steam it, or to switch fuel types, for example, from jet fuel to diesel. All fueling off the tank trailer, however, will come off the valve systems discussed below.

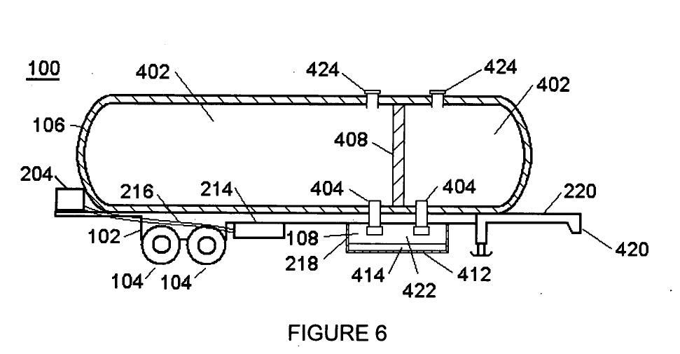

The fluid transfer system 108 comprising fuel-forwarding equipment is shown in FIG. 1 connected to bottom valve 19, which forms part of the fuel loading system. If a top loading system is used as shown in FIG. 6a, then the fuel forwarding equipment would be connected to top loading valve 420. The fuel-forwarding equipment present may vary depending on the preferences of the user, but may include a fuel filter 202, a hose 206, a hose reel 208, and a fuel pump 210. The fuel pump 210 is powered by generator 204 (FIG. 6) and draws fluid through the fuel filter 202 and meter 212 and discharges the fuel through hose 206. For additional safety when using fuels such as aviation fuel, a ground cable 222 may also be included. The type of equipment chosen will also be use-specific, since, for example, different fuels require different filters. The fuel forwarding equipment may be located in a cabinet 218 below the tank 106, in front of the tank 106 on the tongue 220 of the trailer as shown in FIG. 6a, or in a cabinet on the back of the tank trailer 100 (not shown). The fuel pump 210 is preferably located outside the tank 106. Although it is possible to place the fuel pump 210 inside the tank 106, this makes it difficult to repair and maintain. For safety reasons, the generator 204 should be located a safe distance from the fuel pump 210, such as on the back of the trailer as shown in FIG. 6. If a generator 204 is used, then it may be preferable to include a sliptank 214 as shown in FIG. 6 to store fuel for the generator 204 if the generator 204 runs on a different fuel than what is being stored and transported in the tank 106. This may be formed inside the tank, attached underneath the tank, or any other convenient location. A fuel line 216 such as a braided stainless steel line runs from the slip tank 214 to the generator 204. The sliptank 214 is not limited to supplying fuel to a generator 204, and may be used to fuel various equipment, depending on the needs of the user.

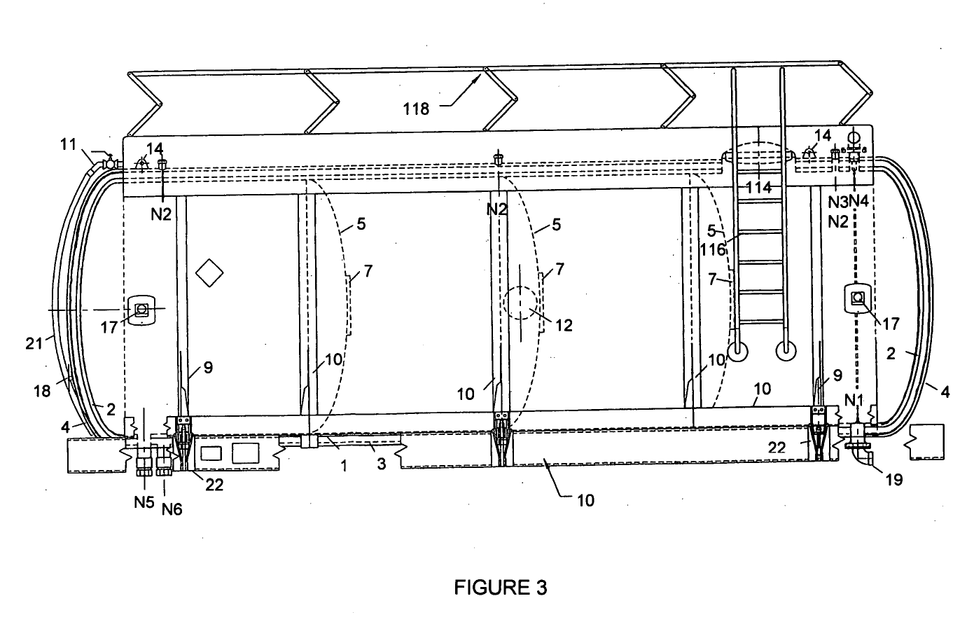

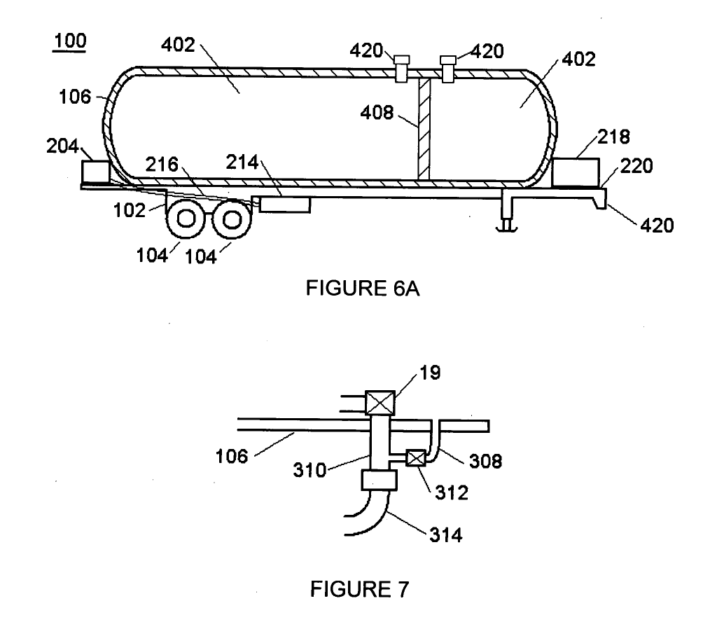

FIG. 3 shows a bottom loading highway tank 100. A bottom loading valve system is included in the fluid transfer system that has venting capabilities such as a vent N4 on the top with rollover protection, and a valve 19 that incorporates anti-siphon and automatic shutoff features, which generally functions with a level sensor 12. The Carter line of products available from Argo-Tech Corporation are convenient to use, as they provide the necessary features, such as model 64168 for a vent, model 64079A for a level sensor and model 64129A for an internal Carter valve. If a 3″ camlock attachment on the valve is used, the size may be reduced depending on the size of hose used to load or off-load the fluid by using camlock reducers. One feature of the Carter valve is that, when the tank is being refilled, the Carter valve ensures that the tank cannot be overfilled, and will close at a predetermined level, such as when 95% capacity is reached. Once the Carter valve is closed, fuel may be left in the load line 314. There may therefore be included, as shown in FIG. 7, an auxiliary line 308 in addition to the main line 310 connected to a valve 312 that can be opened to allow fuel from the load line 314 to be blown out after the Carter valve 19 is closed. The highway tank may also be top loaded as shown in FIG. 6a, in which case the valve system should include overfill protection.

Referring to FIG. 6, the highway tank 100 may also be required to carry multiple fluids, such as regular gas, diesel, jet fuel, “colored” gas or “colored” diesel. It should be noted that current regulations do not permit fueling regular gas into vehicles from a tank trailer such as this, however, it may still be transported and removed on-site. If the highway tank is intended to transport multiple types of fluid, the tank 106 may be divided into plural sections 402 by dividers 408 for separating fuel, each section having a valve system 404, vent 424 and manway (not shown) for loading and unloading the section.

Other reasons for separating the tank into multiple sections also exist. For example, if the highway tank 100 is pulled up a steep hill, and is not completely full, the fluid will run to the back end of the tank, and the resultant shift in weight may cause problems at the hitch 420. To safeguard against this, a divider 408 at the front of the tank 106 may be inserted, and the compartment 402 that is formed can be filled first and emptied last, thus ensuring that there will be weight at the front of tank 106 to allow better traction for the power unit pulling the trailer. Tank 106 also comprises baffles 5, which may also comprise manway collars 7, on the interior of tank 106 to minimize movement of the fuel during transport.

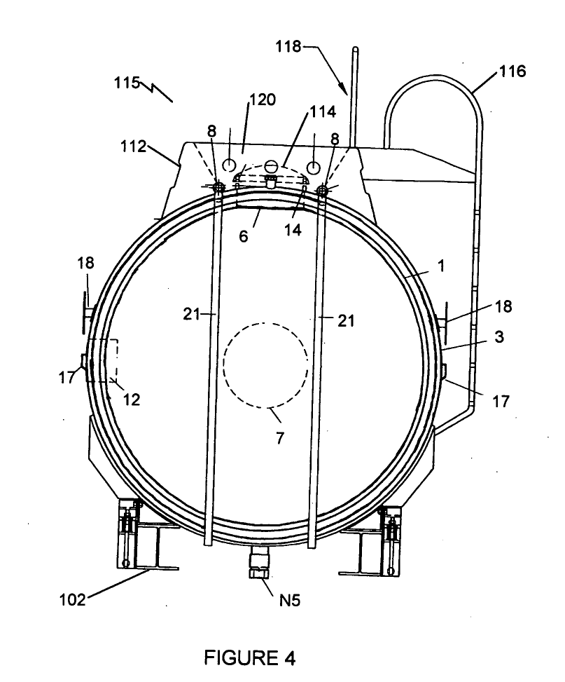

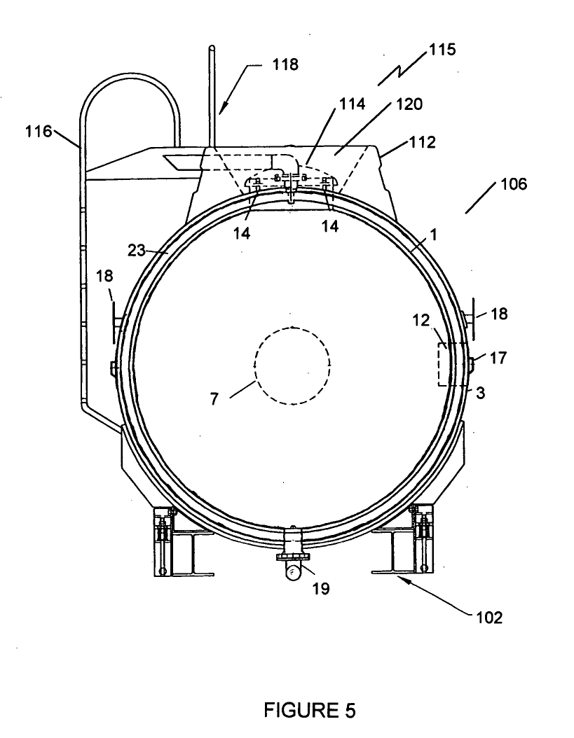

There may also be included a drip tray 412 to catch any leaks from the valve systems, fuel forwarding equipment, and any other connections that may exist. If a cabinet 218 is used to store the fuel forwarding equipment under the tank 106 as shown in FIG. 6, then it becomes convenient to construct the cabinet 218 to incorporate the drip tray 224, such that the drip tray 224 comprises the bottom 414 of the cabinet 218 under the tank 106. The bottom of the cabinet 218 will have a surrounding wall 416 below the access 422 to the cabinet, and the bottom will be provided with a drain 418 to remove any fluid. The drip tray 412 shown in FIG. 4 has a grounding rod 226 which may or may not be included, depending on the fluid used. The spill tray 412 should be large enough to contain a significant leak, such as 100 L. If the fuel forwarding equipment is not stored in a cabinet 218 under the tank 106, a spill tray 412 may still be designed to catch spills or leaks from the Carter valve and fuel forwarding equipment, separately if necessary.

Commonly, double walled storage tanks are constructed of steel, and highway tanks are constructed of aluminum. This invention may be constructed of either aluminum or steel.

Immaterial modifications to the preferred embodiments disclosed here that may be apparent to those skilled in the art fall within the scope of the invention.

1. A highway tank for onsite refueling, the highway tank being double-walled and mobile, and comprising:
a chassis;
ground engaging wheels supported by the chassis;
a tank, the tank being double-walled, the tank mounted on the chassis in a horizontally disposed manner; and
a fluid transfer system connected to the tank for filling and discharging the tank, the fluid transfer system mounted on the chassis and connected to the tank for fluid transfer.

2. The highway tank of claim 1 in which the tank is substantially cylindrical.

3. The highway tank of claim 1 in which the fluid transfer system comprises fuel-forwarding equipment.

4. The highway tank of claim 3 in which the fuel-forwarding equipment comprises a fuel filter, a generator and a fuel pump.

5. The highway tank of claim 4 in which the fuel forwarding equipment is located in a cabinet below the tank.

6. The highway tank of claim 4 in which the fuel forwarding equipment is located in front of the tank.

7. The highway tank of claim 4 in which the generator is located a safe distance from the fuel pump.

8. The highway tank of claim 1 in which the tank has bottom loading equipment.

9. The highway tank of claim 8 in which the fluid transfer system comprises a level sensor, a vent, and a bottom loading valve.

10. The highway tank of claim 1 in which the tank comprises a top loading valve system.

11. The highway tank of claim 10 in which the top loading valve system comprises overfill protection.

12. The highway tank of claim 1 further comprising a sliptank mounted on the chassis to store fuel separate from the tank.

13. The highway tank of claim 1 in which the tank is divided into plural sections for separating fuel, each section having a valve system for loading and unloading the section.

14. The highway tank of claim 1 in which the tank comprises baffles on the interior of the tank.

15. The highway tank of claim 8 in which the fluid transfer system further comprises anti-siphon protection.

16. The highway tank of claim 1 further comprising a drip tray mounted on the chassis and associated with the fluid transfer system to catch spills of fluid occurring during fluid transfer.

17. The highway tank of claim 16 in which the drip tray comprises the bottom of a cabinet under the tank, the bottom of the cabinet having a surrounding wall below the access to the cabinet and the bottom having a drain to remove any fluid.

18. The highway tank of claim 1 in which the walls of the tank are comprised of aluminum.

19. The highway tank of claim 1 in which the walls of the tank are comprised of steel.

20. A method of transporting and storing fluids, the method comprising the steps of:
providing a tank that is double walled on a chassis in a horizontally disposed manner, the chassis also supporting ground engaging wheels, the tank being connected to a fluid transfer system for filling and discharging the tank;
filling the tank with a fluid;
transporting the fluid to a location; and
storing the fluid in the tank at the location.

21. The method of claim 20 in which the tank is substantially cylindrical.

22. The method of claim 20 or 1 further comprising the step of refilling the tank at the location.

23. A method of transporting and storing fuel, the method comprising the steps of:
providing a tank as defined by claims 1;
filling the tank with a fuel;
transporting the fuel to a location;
storing the fuel in the tank at the location; and using the tank at the location to fuel equipment used at the location.
